(19) United States
(12) Patent Application Publication
(10) Pub. No.: US 2024/0380230 A1
(43) Pub. Date: Nov. 14, 2024

(54) CONTROL OF BATTERY OPERATION MODES

(71) Applicant: CPS Technology Holdings LLC, New York, NY (US)

(72) Inventor: Daryl C. BROCKMAN, Shorewood, WI (US)

(21) Appl. No.: 18/690,124

(22) PCT Filed: Sep. 8, 2022
(86) PCT No.: PCT/US2022/042894

§ 371 Date: Mar. 7, 2024

Related U.S. Application Data
(60) Provisional application No. 63/242,942, filed on Sep. 10, 2021.

(51) Int. Cl. H02J 7/00; H01M 10/42; H01M 10/44

(52) U.S. Cl. CPC H02J 7/007; H01M 10/44; H02J 7/00036; H02J 7/0048; H02J 7/0063; H01M 2010/4271; H01M 2010/4278

(57) ABSTRACT

A plug is described. The plug is removably connectable to a battery and comprises a communication interface and a processing circuitry in communication with the communication interface. The processing circuitry is configured to select one of a first operation mode and a second operation mode based on at least one of a request to switch between the first operation mode and the second operation mode; and at least one parameter associated with the battery. The selected first operation mode triggers the battery to operate using set of processes, and the selected second operation mode triggers the battery to operate using a second set of processes. The first set of processes is a subset of the second set of processes. The communication interface is configured to transmit a first indication indicating one of the selected first operation mode and the selected second operation mode.

### TECHNICAL FIELD

This disclosure relates to a method and system for battery system management, more specifically control of operation modes of batteries and/or battery management systems.

### BACKGROUND

Motor-powered and/or electrically powered vehicles tend to rely on using one or more battery systems for providing a starting power and/or at least a portion of a motion power for the vehicle. Such vehicles may include one or more of an air- or watercraft, a rail-guided vehicle, a street vehicle, etc., where a street vehicle may refer to, for example, one or more of cars, trucks, buses, recreational vehicles, etc.

In vehicles, different types of batteries are used, such as traction batteries (for electric or hybrid electric vehicles) and starter batteries. In automotive applications, for example, a starter battery is used for providing the necessary energy/power required for starting a vehicle where a traction battery may generally refer to a battery or energy storage module, which provides motive power to the vehicle, for example.

Conventionally, lead-acid batteries are used as starter batteries for vehicles. However, lead-acid batteries are heavy due to their low energy densities. In contrast to heavy lead-acid batteries, lithium-ion energy storage modules provide high energy densities. In addition, lithium-ion energy storage modules have, for example, a longer service life, less self-discharge, higher energy density, lower weight, improved rapid charging capability and shorter maintenance intervals than conventional lead-acid batteries. However, the lithium-ion chemistry has different needs and requirements as the conventional lead-acid battery.

As battery technology evolves, the demand for improved power sources such as energy storage modules (e.g., batteries, battery cells, etc.) for vehicles continues to grow. For example, lithium-ion batteries/battery cells tend to be very susceptible to heating and/or overheating, which may negatively affect components of the energy storage module. Also, lithium-ion batteries or battery cells tend to be very sensitive with respect to overcharging and deep-discharging of the respective cells or battery, which could negatively affect battery life. Other factors may include discharge of batteries over a period of time, such as batteries that are unused during certain seasons such as winter where the battery become discharged (e.g., as a result of monitoring performed by battery management systems).

In other words, existing battery-based systems lack battery management processes and/or components that adequately protect the battery components and/or help promote longer battery life and/or improve battery/battery system operational characteristics.

### SUMMARY

Some embodiments advantageously provide a method and system for battery system management. In one or more embodiments, a first operation mode (e.g., a sleep mode) and second operation mode (e.g., an operation mode that performs more functions that the first mode) are selectable (e.g., on a plug that is removably connectable to a battery). The first and second operation modes may be selectable via an actuator, such as a depressible button, on the plug. An automatic selection of (and performance of) of the first and second modes may also be triggered from an actuator, such as a depressible button, on the plug. The automatic selection may be an automatic mode based one or more parameters of the battery. The plug may be configured to display the operation modes and/or at least one parameter of the battery such as state of charge.

Some other embodiments may provide remote control of sleep/active operation modes (e.g., via the state of charge indicator actuator such as a depressible button). In an embodiment, remote communication of battery status (e.g., via wired/wireless connection between the battery and a plug) is provided. The plug may be a remote plug. In another embodiment, state of charge of the battery and/or other parameters may be provided via indicators (e.g., light emitting diodes (LEDs) on a state of charge indicator).

According to one aspect, a plug is described. The plug is removably connectable to a battery and comprises a communication interface and a processing circuitry in communication with the communication interface. The processing circuitry is configured to select one of a first operation mode and a second operation mode based on at least one of a request to switch between the first operation mode and the second operation mode; and at least one parameter associated with the battery. The selected first operation mode triggers the battery to operate using set of processes, and the selected second operation mode triggers the battery to operate using a second set of processes. The first set of processes is a subset of the second set of processes. The communication interface is configured to transmit a first indication indicating one of the selected first operation mode and the selected second operation mode.

According to another aspect, a system is described. The system comprises a battery including a battery management system (BMS) configured to determine at least one parameter associated with the battery. The system also includes a plug removably connectable to the battery and comprising a first communication interface and first processing circuitry in communication with the first communication interface. The first processing circuitry is configured to select one of a first operation mode and a second operation mode based on at least one of a request to switch between the first operation mode and the second operation mode; and the at least one parameter associated with the battery. The selected first operation mode triggers the BMS to operate using set of processes. The selected second operation mode triggers the BMS to operate using a second set of processes. The first set of processes is a subset of the second set of processes. The first communication interface is configured to transmit, to the BMS, a first indication indicating one of the selected first operation mode and the selected second operation mode.

According to another aspect, a method in a plug is described. The plug is removably connectable to a battery. The method comprises selecting one of a first operation mode and a second operation mode based on at least one of a request to switch between the first operation mode and the second operation mode; and at least one parameter associated with the battery. The selected first operation mode triggers the battery to operate using set of processes. The selected second operation mode triggers the battery to operate using a second set of processes. The first set of processes is a subset of the second set of processes. The method further includes transmitting a first indication indicating one of the selected first operation mode and the selected second operation mode.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a diagram of an example system according to principles disclosed herein;

FIG. 2 shows an example battery constructed in accordance with the principles of the present disclosure;

FIG. 3 is a block diagram of some entities in the system according to some embodiments of the present disclosure;

FIG. 4 is a flowchart of an example process in a plug according to some embodiments of the present disclosure;

FIG. 5 is a flowchart of another example process in a plug according to some embodiments of the present disclosure;

FIG. 6 shows an example plug, battery, and charger according to some embodiments of the present disclosure;

FIG. 7 shows an example plug on vehicle according to some embodiments of the present disclosure;

FIG. 8 shows an example plug including an actuator and indicators according to some embodiments of the present disclosure;

FIG. 9 shows a view of an example plug according to some embodiments of the present disclosure;

FIG. 10 shows another view of the example plug according to some embodiments of the present disclosure;

FIG. 11 shows one other view of the example plug according to some embodiments of the present disclosure;

FIG. 12 shows yet another view of the example plug according to some embodiments of the present disclosure;

FIG. 13 shows an example connector of a plug according to some embodiments of the present disclosure;

FIG. 14 shows an example battery including one connector according to some embodiments of the present disclosure;

FIG. 15 shows an example battery including a cover according to some embodiments of the present disclosure;

FIG. 16 shows an example plug and battery according to some embodiments of the present disclosure;

FIG. 17 shows an example plug and covered battery according to some embodiments of the present disclosure; and

FIG. 18 shows an example pin arrangement of a plug according to some embodiments of the present disclosure.

### DETAILED DESCRIPTION

Before describing in detail exemplary embodiments, it is noted that the embodiments reside primarily in combinations of apparatus components and processing steps related to battery system management (e.g., using a plug removably connectable to the battery and/or battery management system). Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments, the term “parameter” refers to any parameter related to battery performance, management, operation, etc., as well as performance, management, operation, etc., of the device in which the battery is installed. The parameter may be measured/determined such as voltage, current, temperature, pressure, state of charge. For example, the parameter may be associated with a battery, battery component, vehicle (or any other system), load associated with the battery, etc. A parameter threshold may refer to a threshold associated with a parameter.

An operation mode may refer to one or more modes of operating a battery (and/or BMS and/or associated vehicle/system). The operation mode may be based on one parameter such state of charge of the battery. Further, an operation mode may refer to one or more operation modes such as a first operation mode, a second operation mode, a manual mode, an automatic mode, etc.

A signal may refer to any signal (and/or data, information, etc.) that triggers at least one action and/or triggers a component to perform on action such as determine a charging mode, switch an operation mode, initiate/terminate/maintain the operation mode.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

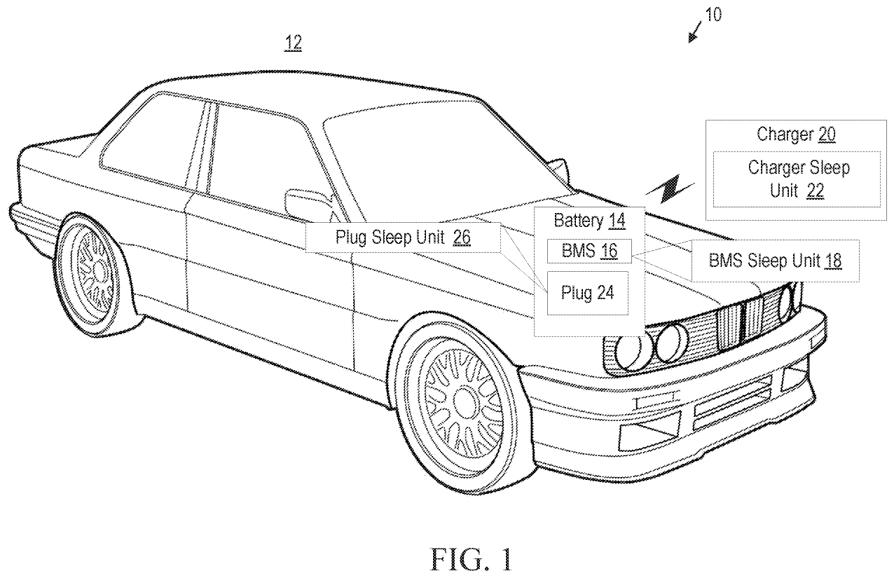

Referring to the drawing figures, in which like elements are referred to by like reference numerals, there is shown in FIG. 1 a diagram of a system 10, according to an embodiment, which comprises one or more vehicles 12 such as a motor-powered and/or electrically powered vehicle. The vehicle 12 comprises battery 14 for powering at least one functions of vehicle 12. Battery 14 may be a lithium-ion based battery that includes one or more energy storage modules. Although a lithium-ion based battery has been described, the teachings described herein are equally applicable to other battery types. Battery 14 includes battery management system (BMS) 16 that is configured to perform one or more battery management functions. In some embodiments, the BMS 16 may measure/determine certain battery parameters, e.g., state of charge (SOC), voltage, etc., and transmit/receive data (and/or signals such as control signals) to/from another system/device. In some other embodiments, BMS 16 may perform one or more processes based on an operation mode.

Further, battery 14 may include one or more plugs 24 configured to trigger one or more modes/functions of BMS 16. Plug 24 may be integrated to any component of system 10. In one or more embodiments, plug 24 is removably or permanently attached to battery 14 via one or more mechanical mechanism, e.g., snap fit, clamp, screw, etc., or integrated within the battery housing (not shown). Charger 20 may be a separate device from (or comprised in) vehicle 12 and/or battery 14 where Charger 20 is configured to charge battery 14 based on at least one criterion, as described herein. One or more entities in vehicle 12 may be located/positioned outside vehicle 12 such as in a charging station or other type of station.

It is contemplated that one or more entities in battery 14 are in communication with each other via one or more of wireless communication, power communication, wired communication, etc. Further, while it may be assumed in one or more embodiments that there is not data or signal communication between battery 14 and vehicle 12, the embodiments described herein are equally applicable to vehicles 12 where there are some data/signal communications between battery 14 and vehicle 12.

A BMS is configured to include a BMS sleep unit 18 that is configured to perform one or more functions as described herein such as with respect to triggering one or more operation modes (e.g., a sleep mode) at BMS 16, for example. Charger 20 is configured to include charger sleep unit 22 that is configured perform one or more Charger 20 functions as described herein such as with respect to charging battery 14 via plug 24. Charger 20 may be a separate device from (or comprised in) vehicle 12 and/or battery 14 and/or BMS 16 where charger 20 is configured to charge battery 14 based on at least one criterion/parameter, as described herein. One or more entities in vehicle 12 may be located/positioned outside vehicle 12 such as in a charging station or other type of station.

Charger 20 is configured to include a charger sleep unit 22 that is configured to perform any step and/or task and/or process and/or method and/or feature described in the present disclosure, e.g., to perform one or more charging functions such as for charging battery 14 using plug 24.

It is contemplated that one or more entities in battery 14 are in communication with each other via one or more of wireless communication, power communication, wired communication, etc. Further, while it may be assumed in one or more embodiments that there is not data or signal communication between vehicle 12, battery 14, BMS 16, charger 20, and plug 24, the embodiments described herein are equally applicable to vehicles 12 where there is at least some data/signal communication between vehicle 12, battery 14, BMS 16, charger 20, and plug 24 and/or any other device.

Although plug 24 is shown as being part of battery 14, plug 24 may be standalone and/or or part of any other component of system 10 and/or be in communication with any component of system 10.

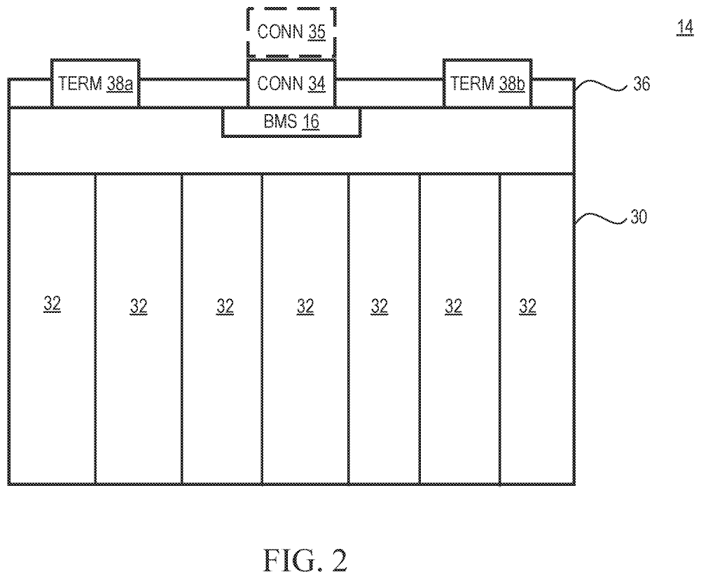

FIG. 2 shows an example battery 14 constructed in accordance with the principles of the present disclosure. Battery 14 includes a housing 30 into which one or more cells 32 are positioned. The cells 32 may be electrically interconnected (not shown in the FIGS.), such as via an electrically conductive bus bar system which electrically interconnects the cells 32 in an electrically serial, electrically parallel or combination of electrically serial and parallel manner, depending on the intended voltage and current requirements.

A battery monitoring system (BMS) 16 may be included. BMS 16 may include a monitoring connector 34 that allows for a removable external connection any other component of system 10 (e.g., to the vehicle's data bus, to some other communication device such as charger 20, plug 24, etc.) and/or internal connection, e.g., any components of battery 14 and/or BMS 16. Connector 34 may be comprised in BMS 16. In some embodiments, connector 34 may be configured to removably couple and/or connect (electrically, physically) to another connector (such as connector 35 which may be comprised in plug 24). The monitoring connector 34 can, in some embodiments, be integrated with the housing 30, such as in a cover 36 of the housing 30. In some embodiments, connector 34 may be configured to communicate with and/or couple to plug 24 (e.g., via connector 35). In some other embodiments, the functions of connector 34 and/or connector 35 may be performed by plug 24 (and/or BMS 16). Battery 14 also includes terminals, such as a positive terminal 38a and a negative terminal 38b (collectively referred to as terminals 38) to provide the contact points for electrical connection of the battery 14 (e.g., to charger 20 such as for charging and/or measuring parameters of battery 14, to the vehicle 12 to provide the auxiliary power to the vehicle and/or BMS 16 to power BMS 16 (and/or for charging/discharging functions)). Terminals 38 may be arranged to protrude through housing 30, such as protruding through cover 36. Terminals 38 may be electrically connected to the bus bars inside housing 30 and/or directly connected to the cells 32 (bus bars and direct connection not shown). In some embodiments, housing 30 includes one or more vent holes to allow venting from one or more of the cells 32. Further, battery 14 may be arranged to provide many power capacities and physical sizes, and to operate under various parameters and parameter ranges. It is also noted that implementations of battery 14 some can be scaled to provide various capacities. For example, in some embodiments, the power capacity of battery 14 can range from 25 Ah to 75 Ah. It is noted, however, that this is range is merely an example, and that it is contemplated that embodiments of battery 14 can be arranged to provide less than a 25 Ah capacity or more than a 75 Ah capacity. Power capacity scaling can be accomplished, for example, by using higher or lower power capacity cells 32 in the housing 21, and/or by using fewer or more cells 32 in the housing 30. In some embodiments, battery 14 may be incorporated as part of a vehicle such as an electric vehicle (EV) or another type of vehicle where battery power is needed. Other electrical parameters of the battery 14 can be adjusted/accommodated by using cells 32 that may cumulatively have the desired operational characteristics, e.g., voltage, charging capacity/rate, discharge rate, etc. Thermal properties can be managed based on cell 32 characteristics, the use of heat sinks and/or thermal energy discharge plates, etc., within or external to the housing 30.

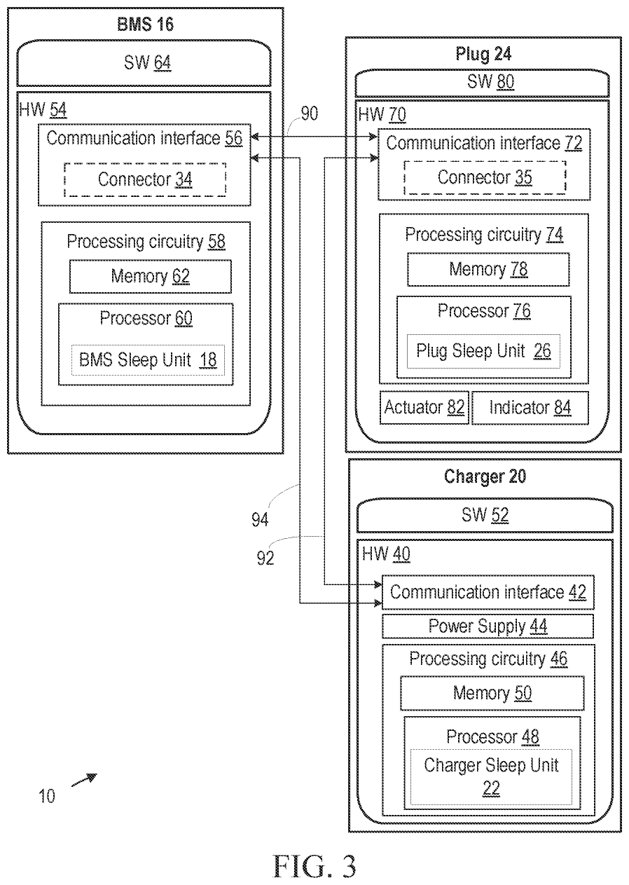

Example implementations, in accordance with an embodiment, of BMS 16, plug 24 and charger 20 discussed in the preceding paragraphs will now be described with reference to FIG. 3. BMS 16 may have hardware 54 that may include a communication interface 56 that is configured to communicate with one or more entities in system 10 (and/or outside of system 10) via wired and/or wireless communication. The communication may be protocol based communication. Further, communication interface 56 is shown as including connector 34. However, connector 34 may be standalone, comprised in battery 14 and/or BMS 16, or in any other component of system 10.

The hardware 54 includes processing circuitry 58. The processing circuitry 58 may include a processor 60 and memory 62. In particular, in addition to or instead of a processor, such as a central processing unit, and memory, the processing circuitry 58 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 60 may be configured to access (e.g., write to and/or read from) memory 62, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

BMS 16 may further comprise software 64, which is stored in, for example, memory 62, or stored in external memory (e.g., database, etc.) accessible by the BMS 16. The software 64 may be executable by the processing circuitry 58.

The processing circuitry 58 may be configured to control any of the methods and/or processes described herein and/or to cause such methods, and/or processes to be performed, e.g., by BMS 16. The processor 60 corresponds to one or more processors 60 for performing BMS 16 functions described herein. The BMS 16 includes memory 62 that is configured to store data, programmatic software code and/or other information described herein. In some embodiments, the software 64 may include instructions that, when executed by the processor 60 and/or processing circuitry 58, causes the processor 60 and/or processing circuitry 58 to perform the processes described herein with respect to BMS 16. For example, the processing circuitry 58 of the BMS 16 may include BMS sleep unit 18 that is configured to perform one or more BMS 16 functions such as with respect to performing one or more actions associated with operating BMS 16 and/or battery 14 based on one or more operation modes.

Charger 20 already referred to where Charger 20 may be separate from vehicle 12. Charger 20 may have hardware 40 that may include a communication interface 42 that is configured to communication with one or more entities in system 10 via wired and/or wireless communication. The communication may be protocol based communications. Charger 20 includes a power supply 44 that is configured to provide power, energy, etc. to battery 14 via one or more power communications links (e.g., wired and/or wireless power transfer) such as to charge battery 14 to a dynamically or preconfigured SOC level/threshold as described herein.

The hardware 40 includes processing circuitry 46. The processing circuitry 46 may include a processor 48 and memory 50. In particular, in addition to or instead of a processor, such as a central processing unit, and memory, the processing circuitry 46 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) memory 50, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the charger 20 may further comprise software 52, which is stored in, for example, memory 50, or stored in external memory (e.g., database, etc.) accessible by the charger 20. The software 52 may be executable by the processing circuitry 46.

The processing circuitry 46 may be configured to control any of the methods and/or processes described herein and/or to cause such methods, and/or processes to be performed, e.g., by charger 20. The processor 48 corresponds to one or more processors 48 for performing charger 20 functions described herein. The charger 20 includes memory 50 that is configured to store data, programmatic software code and/or other information described herein. In some embodiments, the software 52 may include instructions that, when executed by the processor 48 and/or processing circuitry 46, causes the processor 48 and/or processing circuitry 46 to perform the processes described herein with respect to charger 20. For example, the processing circuitry 46 of the charger 20 may include charger sleep unit 22 that is configured to perform any step and/or task and/or process and/or method and/or feature described in the present disclosure, e.g., one or more steps for charging battery 14 via plug 24. While charger sleep unit 22 is illustrated as being part of charger 20, charger sleep unit 22 and associated functions described herein may be implemented in a device separate from charger 20 such as in battery 14 or another device.

Further, plug 24 includes hardware 70, and the hardware 28 may include a communication interface 72 for performing wired and/or wireless communication with BMS 16 and/or charger 20 and/or a wireless device (e.g., mobile wireless device) and/or any other device. For example, communication interface 72 of plug 24 may communicate with communication interface 56 of BMS 16 via communication link 90. In addition, communication interface 72 of plug 24 may communicate with communication interface 42 of charger 20 via communication link 92. Similarly, communication interface 42 may communicate with communication interface 56 via communication link 94. At least one of communication links 90, 92, 94 may refer to a wired/wireless connection (such as WiFi, Bluetooth, etc.).

Although communication interface 72 is shown as including connector 35, connector 35 may be standalone, comprised in plug 24, or in any other component of system 10.

In the embodiment shown, the hardware 70 of plug 24 includes processing circuitry 74. The processing circuitry 74 may include a processor 76 and a memory 78. In particular, in addition to or instead of a processor, such as a central processing unit, and memory, the processing circuitry 74 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 76 may be configured to access (e.g., write to and/or read from) the memory 78, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the plug further has software 80 stored internally in, for example, memory 78, or stored in external memory (e.g., database, etc.) accessible by the plug 24 via an external connection. The software 80 may be executable by the processing circuitry 74. The processing circuitry 74 may be configured to control any of the methods and/or processes described herein and/or to cause such methods, and/or processes to be performed, e.g., by plug 24. Processor 76 corresponds to one or more processors 76 for performing plug 24 functions described herein. The memory 78 is configured to store data, programmatic software code and/or other information described herein. In some embodiments, the software 80 may include instructions that, when executed by the processor 76 and/or processing circuitry 74, causes the processor 76 and/or processing circuitry 74 to perform the processes described herein with respect to plug 24. For example, processing circuitry 74 of plug 24 may include plug sleep unit 26 that is configured to perform one or more plug 24 functions as described herein, e.g., selecting one or more operation modes.

Plug 24 may further include actuator 82 and/or indicator 84. Actuator 82 may be, in some embodiments, a depressible button, and may be configured to accept user input (e.g., by pressing actuator 82) and/or to trigger a mode of operation for battery 14 and/or BMS 16 (e.g., by transmitting a request). Indicator 84 may be configured to provide one or more indications. For example, indicator 84 may be a display, a light emitting diode (LED) indictor, a light bulb, etc. In some embodiments, indicator 84 may be configured to provide an indication associated with a status of battery 14 and/or BMS 16 such as a state of charge (SOC) indication, a mode operation indication, or an indication associated with any other parameter. Actuator 82 and/or indicator 84 may also be comprised in battery 14 and/or charger 20 and perform actuator 82 and/or indicator 84 functions as part of battery 14 and/or charger 20, respectively.

In some other embodiments, plug 24 may provide communication module functionality such as between battery 14 and Charger 20 such that plug sleep unit 26 and associated functionality described herein may be performed by BMS 16 or another entity/device of battery 14.

Although FIGS. 1 and 3 show one or more “units” such as BMS sleep unit 18, charger sleep unit 22, plug sleep unit 26 as being within a respective processor, it is contemplated that these units may be implemented such that a portion of the unit is stored in a corresponding memory within the processing circuitry. In other words, the units may be implemented in hardware, software or in a combination of hardware and software within the processing circuitry.

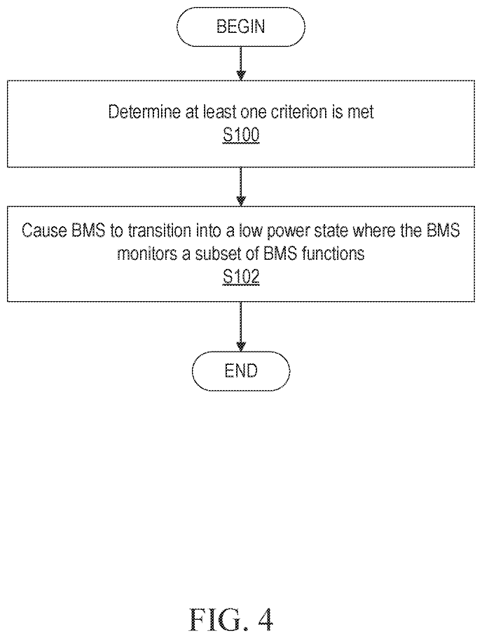

FIG. 4 is a flowchart of an example process in an integrated plug 24 according to some embodiments of the present invention. One or more blocks described herein may be performed by one or more elements of plug 24 such as by one or more of processing circuitry 74 (including the plug sleep unit 26), processor 76, and/or communication interface 72 (and/or connector 35) and/or actuator 82 and/or indicator 84. Plug 24 is configured to determine (Block S100) at least one criterion is met. Plug 24 is further configured to cause (Block S102) BMS 16 to transition into a low power state, e.g., where the BMS 16 monitors a subset of BMS functions. Low power state may correspond to any power state that consumes less energy than another power state that can be implemented by BMS 16. The at least one criterion may include determining vehicle 12 is not in use, for example. Alternatively, Blocks S100 and S102 may be performed by BMS 16 where BMS 16 monitors conditions/at least one criterion and determines to trigger an action such as to transition into a low power state such as via one or more of processing circuitry 58, processor 60, sleep unit 26 (located in BMS 16), etc.

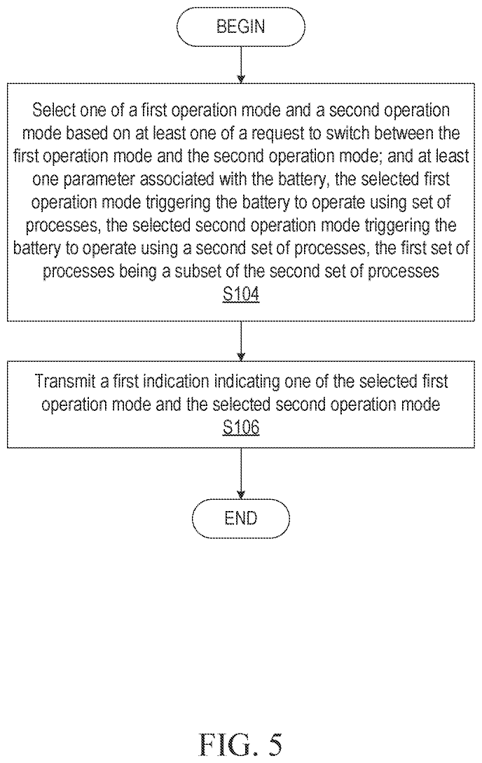

FIG. 5 is a flowchart of an example process (i.e., method) in a plug 24 according to some embodiments of the present invention. One or more blocks described herein may be performed by one or more elements of plug 24 such as by one or more of processing circuitry 74 (including the plug sleep unit 26), processor 76, and/or communication interface 72 (and/or connector 35) and/or actuator 82 and/or indicator 84. Plug 24 is configured to select (Block S104) one of a first operation mode and a second operation mode based on at least one of a request to switch between the first operation mode and the second operation mode; and at least one parameter associated with the battery 14. The selected first operation mode triggers the battery 14 to operate using set of processes, and the selected second operation mode triggers the battery 14 to operate using a second set of processes The first set of processes is a subset of the second set of processes. Plug 24 is further configured to transmit (Block S106) a first indication indicating one of the selected first operation mode and the selected second operation mode.

In some embodiments, the method further includes transmitting the request to switch between the first operation mode and the second operation mode.

In some other embodiments, the method further includes transmitting the request to trigger the selection between the first operation mode and the second operation mode to be automatic based on the at least one parameter associated with the battery 14.

In an embodiment, the method further includes displaying a second indication of at least one of the at least one parameter, the selected first operation mode, the selected second operation mode, and whether selection between the first operation mode and the second operation mode is automatic.

In another embodiment, the method further includes receiving and transferring electrical power to charge the battery 14.

In some embodiments, the method further includes at least one of receiving and transmitting battery management system signals (e.g., from/to BMS 16).

In one embodiment, the at least one parameter includes a state of charge.

In another embodiment, the first operation mode is a sleep mode triggering the battery 14 to consume less power than the second operation mode.

Having described the general process flow of arrangements of the disclosure and having provided examples of hardware and software arrangements for implementing the processes and functions of the disclosure, the sections below provide details and examples of arrangements for one or more process related to battery management in a system. One or more plug 24 functions described below may be performed by one or more of communication interface 72 (and/or connector 35), processing circuitry 74, processor 76, plug sleep unit 26, actuator 82, indicator 86, etc. One or more BMS 16 functions described below may be performed by one or more of communication interface 56, processing circuitry 58, processor 60, BMS sleep unit 18, and connector 34, etc. One or more Charger 20 functions described below may be performed by one or more of communication interface 42, power supply 44, processing circuitry 46, processor 48, charger sleep unit 22, etc.

According to one or more embodiments, a battery/state of charge indicator/charging system is provided. The teachings described herein are applicable to any battery technology, particularly 12V starting, lighting and ignition (SLI) applications and seasonal use vehicles 12.

System 10 has a plug 24, connectable to the battery 14. Plug 24 allows for connecting indicator 84 (e.g., a state of charge indicator) directly to the battery 14 (e.g., without being directly connected to terminals 38). This is convenient and important for vehicles 12 where there may already be multiple electrical accessories that have already been added to the terminals 38, making additional incremental additions to the terminal connections potentially unsafe with the risk of a short circuit, inconvenient, or resulting in a poor electrical connection. The plug 24 (e.g., including indicator 84 such as a state of charge indicator) is designed in such a way that insertion/connection to battery 14 (e.g., via connectors 34, 35) is convenient, weather and vibration proof.

Plug 24 may be arranged and/or configured to conform to the various means that different vehicle manufacturers use to retain the battery 14. The plug 24 (and/or its wired connection design) may be arranged to not to interfere with original equipment (OE) battery hold down such as for maximum convenience and flexibility in use.

For seasonal use vehicles 12 (or any other vehicle 12), it may be important to managing battery state of charge to an appropriate level to maximize life and prevent damage to the battery 14 due to over discharge. Advanced (lithium) batteries may have a BMS 16 which monitors and manages various system parameters. The BMS 16 may be configured to have a low power consumption level. However, having a low power consumption level, over several months of off-season storage, may result in over discharge of the battery 14 (causing damage to battery performance), or at least discharge to a level where the battery 14 cannot deliver enough power for its intended application, e.g., to start an engine.

In some embodiments, one or more methods to manage/select one or more operation modes is described. The method may include one or more steps for addressing negative impact of BMS power consumption. The one or more steps may include automatically triggering automatically a first operation mode (e.g., “storage sleep mode”). The first operation mode may put the BMS 16 into a first power state (e.g., low power state). The first power state may trigger the BMS 16 to only monitor some functions (e.g., the most important functions) such as a subset of BMS 16 functions being active and/or operating. The first operation mode can be triggered by determining a state of vehicle 12 (e.g., detecting the vehicle 12 is not in use), via a combination of parameters such as input/output current or voltage, and/or a time based component. Conversely, the battery 14 and/or BMS 16 may be configured to also automatically exit the first operation mode (e.g., sleep mode) and enter a second operating mode. The automatic exit may be based on a change in one or more parameters such as input/output voltage or current. Further, a connection (e.g., Bluetooth or other wired/wireless connection) to BMS 16 and/or plug 24 and/or charger 20 (e.g., the “operating system” or communication interface of BMS 16 and/or plug 24 and/or charger 20) may allow for user customization of the operating modes triggers (e.g., sleep mode triggers) such as via a mobile application or other software. Operating mode triggers may also be updated via manufacturer over the air firmware updates or customization, in addition to manufacturer retrieval of battery use (or abuse) historical data.

The one or more steps of the method may include a user/manually triggered entry to/exit form the first operating mode (e.g., “storage sleep mode”), which may be initiated by actuator 82 (e.g., a switch, button, selector, etc.). Although actuator 82 is described as comprised in plug 24, actuator 82 may also be comprised in battery 17 and/or charger 20. The manually triggered steps may also be customized and/or controlled via software 80 and a wireless connection such as via communication interface 72 of plug 24.

The plug 24 (e.g., removably connectable to the battery 14) may facilitates a physical connection and access to the BMS 16 for software updates or user configuration of the battery management system functions via computer or mobile device. The addition of BLUETOOTH or wireless capabilities via the plug 24 into the system 10 and/or with a software application on the mobile device may enable use of the capabilities of the mobile device, such as GPS enabled geofencing for security purposes (acting as a remote power shutoff), or as an input for activating the first operating mode (e.g., sleep mode) during times when the vehicle 12 is not in use. For example, battery 14 (and/or BMS 16) may be selected to operate using the first operation mode (e.g., sleep mode) on predetermined days (e.g., weekdays if the vehicle 12 is only used on weekends). In addition, communication interface 72 (and/or communication interface 56) may be used to configure plug 24 (and/or BMS 16) with programmable/dynamically triggerable time or calendar based events (putting the battery 14 in a summer use vehicle 12 such as to sleep during winter months).

Therefore, the integrated plug 24 provides various methods of implementing one or more operating modes (e.g., sleep mode at BMS 16) and executing communications with an external device (e.g., mobile device).

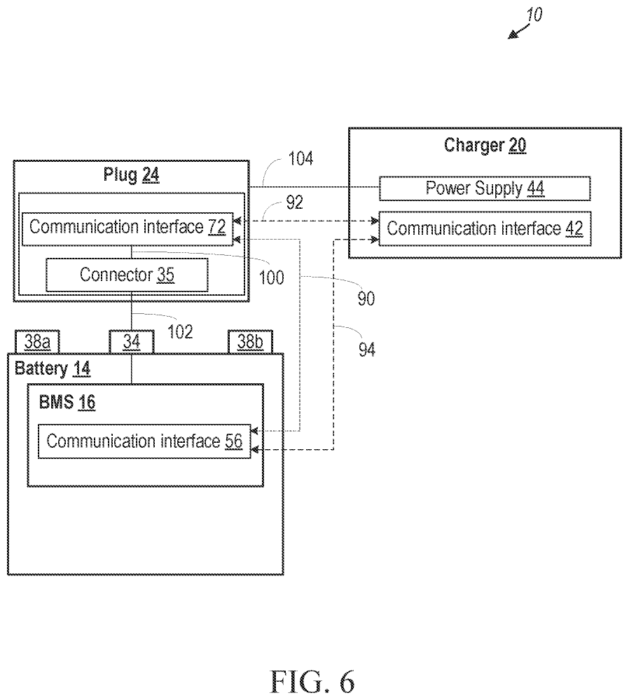

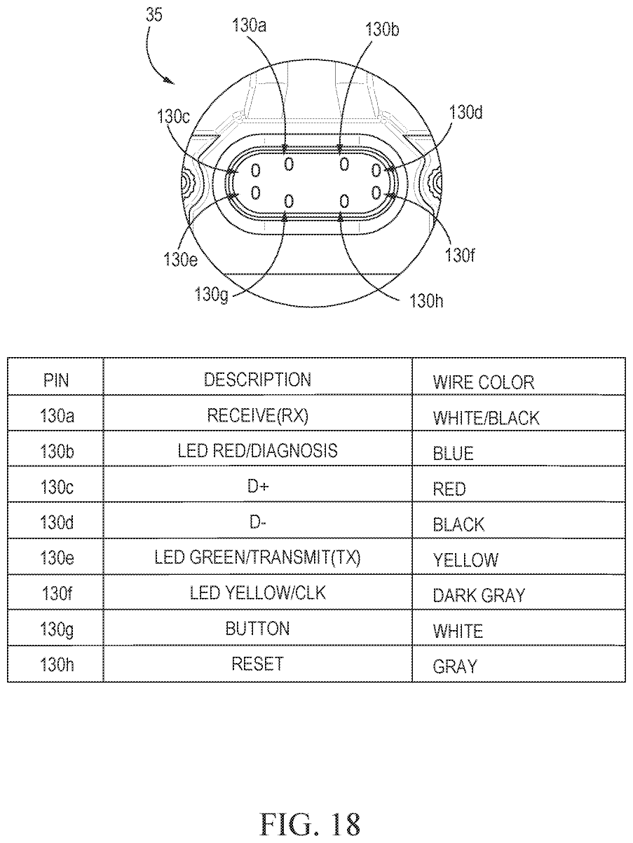

FIG. 6 shows an example plug 24 which may be removably connectable to a battery 14 and/or charger 20. Plug 24 may include communication interface 72 which may include connector 35 connected via connection link 100 (e.g., a cord). Connector 35 may be connected and/or coupled to connector 34 on battery 14 via connection link 102 (e.g., using one or more pins as shown in FIG. 18). Connector 34 may be connected to one or more components of battery 14 such as BMS 16 (and/or communication interface 56). Plug 24 (and/or connectors 34, 35) may be beneficial because a direct connection to the BMS 16 is provided (i.e., without having to connect to terminals 38a, 38b). Further, plug 24 may receive connection link 104 (e.g., a cord for charging battery 14). Plug 24 may be configured to receive electrical power from charger 20 (e.g., power supply) and transfer the electrical power to BMS 16 and/or battery 14. Further, each one of battery 14, BMS 16, charger 20, and plug 24 may communicate to each other using communication links 90, 92, 94 as shown in FIG. 3.

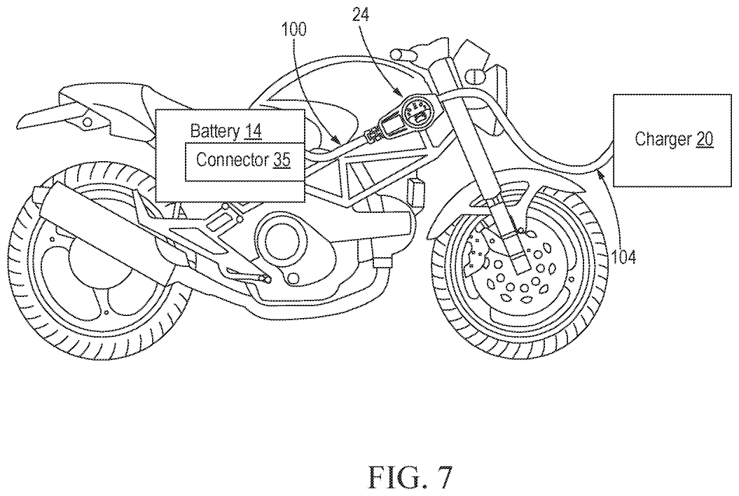

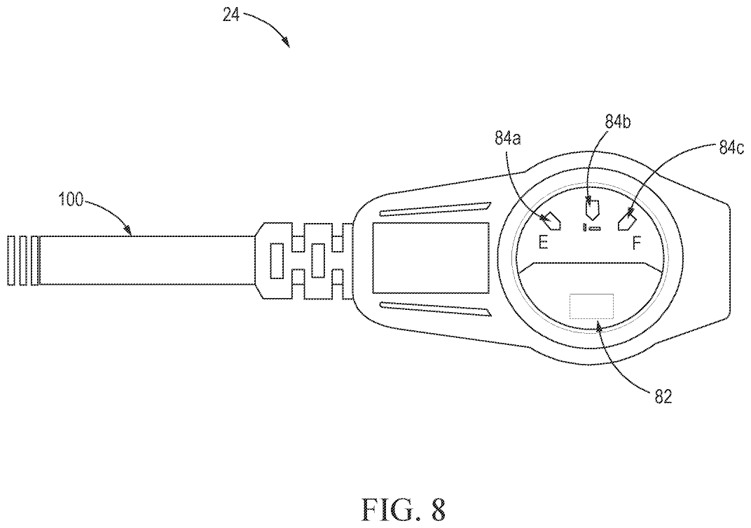

FIG. 7 shows an example plug on vehicle (e.g., motorcycle) according to some embodiments of the present disclosure. Plug 24 is removably connected to battery 14 via connection link 100 (e.g., cord), connector 35 (and/or connector 34, not shown). Plug 24 may also be connected to charger 20 via connection link 104 (e.g., charger cord). One or more indicators (shown in FIGS. 3 and 8) such as “POWERLINK” indicator may be routed to a visible and accessible location on the motorcycle, thereby making it easy to view the indictors and/or actuators usable to control sleep/storage mode and/or connect to charger 20.

FIG. 8 shows an example plug including an actuator 82 and indicators according to some embodiments of the present disclosure. Plug 24 includes connection link 100 and connector 35 connected to connection link 100. Further, plug 24 may include receptacle 110 arranged to receive a connection link 104 for receiving electrical power and/or transferring the electrical power to battery 14 (and/or BMS 16) via connection link 100 and/or connector 35. Plug 24 may include one or more actuators 82 such as to select operation modes (e.g., first and second operation modes, automatic mode, manual mode, etc.). For example, actuator 82 may be used to toggle sleep/storage mode, increase battery power storage time during non-use, etc.

Plug 24 may further include indicators 84 (e.g., indicators 84a, 84b, 84c, or any other type and/or quantity of indicators). Indicator 84a may be a red LED (or any other color) configured to indicate low state of charge (or an indication associated with any other parameter) such as less than a first threshold. Indicator 84b may be an amber LED (or any other color) configured to indicate partial state of charge (or an indication associated with any other parameter) such as less than a second threshold. Indicator 84c may be a green LED (or any other color) configured to indicate fully charged (or an indication associated with any other parameter) such as greater than a third threshold. Indicators 84 may also include indication of operation mode or any other indication. Indicators 84 may be LED lights or any other indicator and may be configured to consume power at a predetermined rate (e.g., 3 Ah).

In some embodiments, any indicator 84 (e.g., indicator 84c which may be a green LED or other visible indicator) may be configured to flash one or more times (e.g., three times) when switching to/from operation modes (e.g., sleep or active modes). In some other embodiments, any indicator 84 (e.g., indicator 84c which may be a green LED) may be configured to indicate “everything ok” and “battery fully charged” such as by keeping the green LED on. In an embodiment, a plurality of illumination sequences (e.g., illumination sequences of amber or red LEDs) may be triggered such as by using any indicator 84. The plurality of illumination sequences may be used to communicate “partially charged”, “battery currently charging”, “exceeded maximum temperature” or other errors or faults, etc.

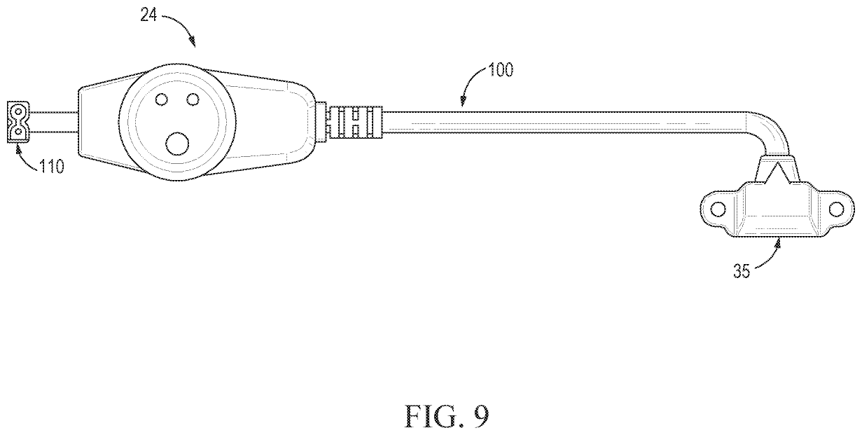

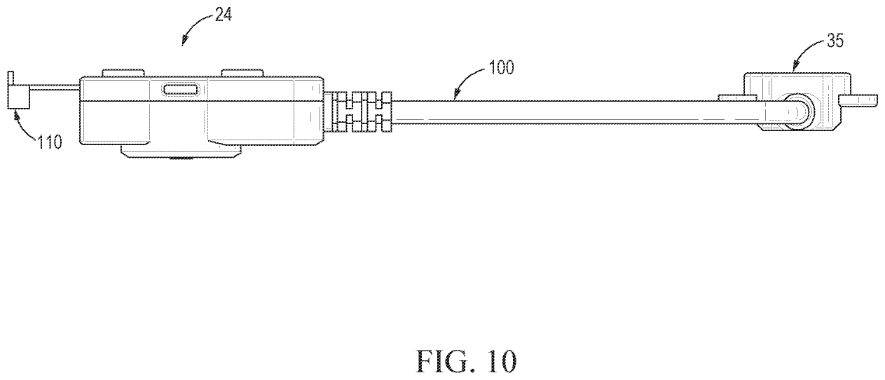

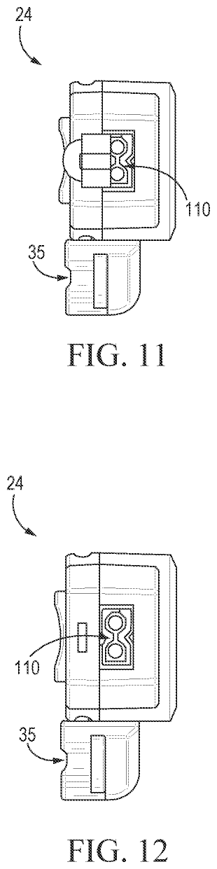

FIG. 9 shows a view (a side view) of the example plug of FIG. 8. FIG. 10 shows another view of the example plug according to some embodiments of the present disclosure. FIG. 11 shows one other view of the example plug showing an example receptacle 110 and connector 35. FIG. 12 shows yet another view of the example plug including another example receptacle 110.

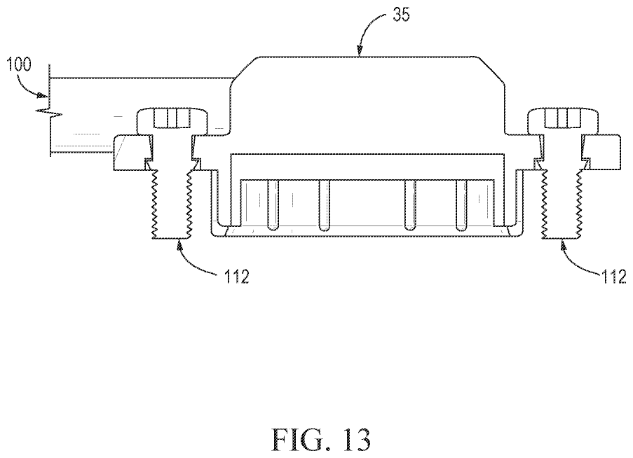

FIG. 13 shows an example connector of a plug (e.g., a cross section view of the connection) according to some embodiments of the present disclosure. Connector 35 may include one or more fasteners 112 which may be arranged to fasten connector 35 to connector 34 of battery 14 and/or to battery 14.

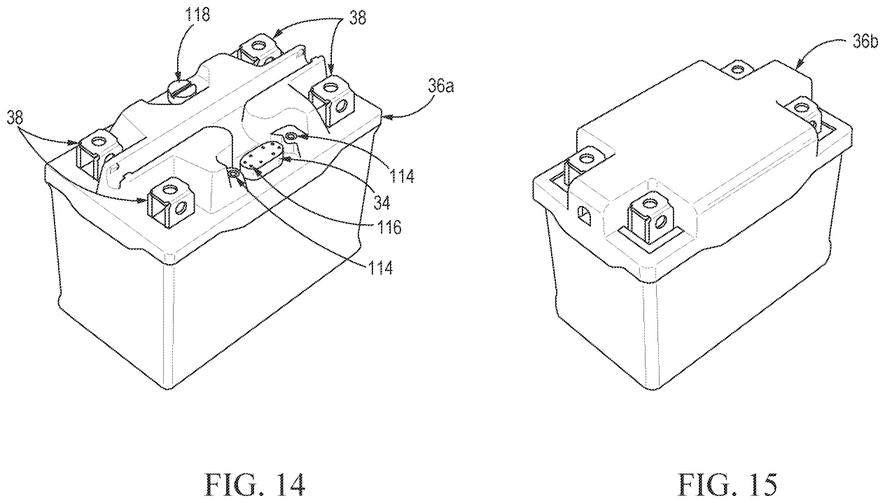

FIG. 14 shows an example battery including one connector according to some embodiments of the present disclosure. Battery 14 may include a cover such as cover 36a. The cover may include connector 34 and fastener receivers 114 (arranged to received fasteners 112). Connector 34 may include pin receivers 116 arranged to receive pins of connector 35. Cover 36a may be fastened to the battery using cover fastener 118. FIG. 15 shows an example battery including a cover according to some embodiments of the present disclosure. Battery 14 (e.g., as shown in FIG. 14) is covered using covered 36 which allows terminals 38 to be exposed.

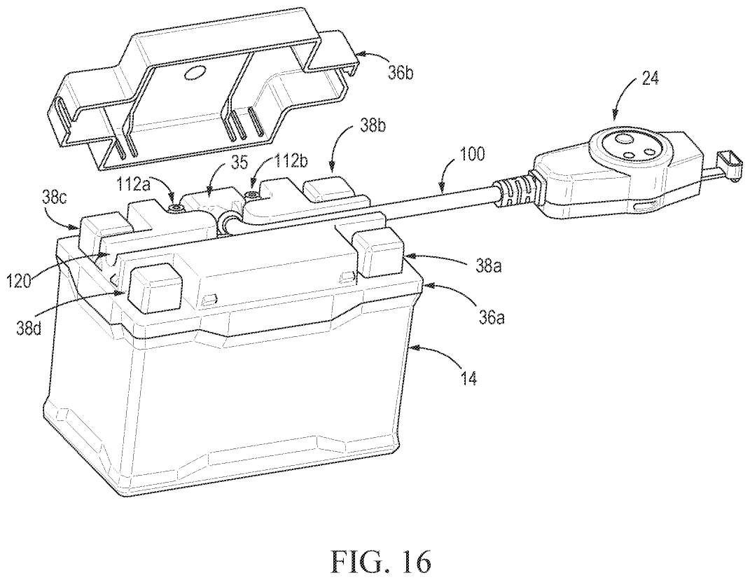

FIG. 16 shows an example plug and battery according to some embodiments of the present disclosure. Plug 24 is removably connected to battery 14 via connection link 100, connector 35, and fastener 112a, 112b. Connection link 100 is routed via channel 120 which is arranged to provide a space to receive and secure connection link 100, e.g., such that connection link 100 does not protrude above cover 36a and/or does not come in contact with cover 36b and/or is further secured by cover 36b. Battery 14 as shown in FIG. 16 includes terminals 38 (e.g., terminals 38a, 38b, 38c, 38d) which may be covered.

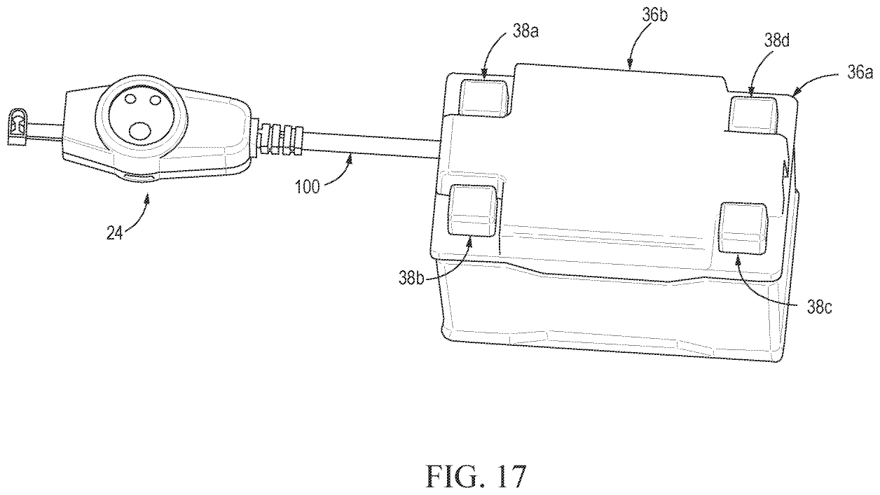

FIG. 17 shows an example plug and covered battery according to some embodiments of the present disclosure. Cover 36b has been placed over cover 36b and coupled together, where connection link 100 of plug 24 is routed outside of battery 14 (via channel 120, an opening on cover 36a and/or cover 36b, etc.).

FIG. 18 shows an example pin arrangement of a plug according to some embodiments of the present disclosure. Connector 35 of plug 24 may include one or more pins 130 (e.g., conductors in electrical contact with the components of plug 24 such as communication interface 72, processing circuitry 74, actuator 82, indicator 84, etc.). Pins 130 may be received by pin receivers 116 (FIG. 14) such as to establish electrical connection with the pin receivers 116 which may be in electrical connection with BMS 16 (e.g., communication interface 56, processing circuitry 58, etc.) and/or other components of battery 14. That is, pins 130 may be configured and/or arranged to provide electrical and/or data communication between plug 24 and BMS 16 and/or battery 14. In one nonlimiting example (e.g., with respect to plug 24 (or BMS 16)), pin 130a may be used to receive signals (e.g., control signals, data, etc.). Pin 130b may be used for LED indications (e.g., red) and/or diagnosis. Pins 130c, 130d may be used for D+ and D−, respectively, which may refer to differential pair lines. Pin 130e may be used for LED indications (e.g., green) and/or transmitting signals (e.g., control signals, data, etc.). Pin 130f may be used for LED indications (e.g., yellow) and/or transmitting signals (e.g., clock signals). Pin 130g may be used to transmit/receive actuator 82 signals (e.g., to switch between operation modes). Pin 130h may be used for sending/receiving reset signals. It is noted that connector 35 is not limited to the pins and/or pin configuration/arrangement and/or quantity of pins as shown in FIG. 18, and may include any other connection method, configuration/arrangement, and/or quantity. Also, connector 35 is not limited to the functions of each pin shown in FIG. 18.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings and the following claims.

1. A plug, the plug being removably connectable to a battery and comprising a communication interface and a processing circuitry in communication with the communication interface:
the processing circuitry being configured to:
select one of a first operation mode and a second operation mode based on at least one of:
a request to switch between the first operation mode and the second operation mode; and
at least one parameter associated with the battery;
the selected first operation mode triggering the battery to operate using a first set of processes, the selected second operation mode triggering the battery to operate using a second set of processes, the first set of processes being a subset of the second set of processes; and
the communication interface being configured to:
transmit a first indication indicating one of the selected first operation mode and the selected second operation mode.

2. The plug of claim 1, wherein the plug further includes an actuator in communication with the processing circuitry and configured to:
cause transmission, to the processing circuitry, of the request to switch between the first operation mode and the second operation mode.

3. The plug of claim 2, wherein the actuator is further configured to:
cause transmission of the request to trigger the selection between the first operation mode and the second operation mode to be automatic based on the at least one parameter associated with the battery.

4. The plug of claim 1, wherein the plug further comprises an indictor configured to:
display a second indication of at least one of the at least one parameter, the selected first operation mode, the selected second operation mode, and whether selection between the first operation mode and the second operation mode is automatic.

5. The plug of claim 1, wherein the plug further includes a receptacle configured to:
receive and transfer electrical power to charge the battery.

6. The plug of claim 1, wherein the communication interface further includes a connector configured to:
at least one of receive and transmit battery management system signals.

7. The plug of claim 1, wherein the at least one parameter includes a state of charge.

8. The plug of claim 1, wherein the first operation mode is a sleep mode triggering the battery to consume less power than the second operation mode.

9. A system, the system comprising
a battery including:
a battery management system, BMS, configured to determine at least one parameter associated with the battery; and
a plug removably connectable to the battery and comprising a first communication interface and first processing circuitry in communication with the first communication interface:
the first processing circuitry being configured to:
select one of a first operation mode and a second operation mode based on at least one of:
a request to switch between the first operation mode and the second operation mode; and
the at least one parameter associated with the battery;
the selected first operation mode triggering the BMS to operate using a first set of processes, the selected second operation mode triggering the BMS to operate using a second set of processes, the first set of processes being a subset of the second set of processes; and
the first communication interface being configured to:
transmit, to the BMS a first indication indicating one of the selected first operation mode and the selected second operation mode.

10. The system of claim 9, wherein the plug further includes an actuator in communication with the first processing circuitry and configured to:
cause transmission, to the first processing circuitry, of the request to switch between the first operation mode and the second operation mode.

11. The system of claim 10, wherein the actuator is further configured to:
cause transmission, to the first processing circuitry, of the request to trigger the selection between the first operation mode and the second operation mode to be automatic, the selection to be automatic triggering the first communication interface to transmit a third indication indicating the BMS to automatically switch between the first and second operation modes based on the at least one parameter associated with the battery.

12. The system of claim 11, wherein the BMS includes a second communication interface configured to:
receive at least one of:
the first indication indicating one of the selected first operation mode and the selected second operation mode; and
the third indication indicating the BMS to automatically switch between the first and second operation modes based on the at least one parameter associated with the battery.

13. The system of claim 12, wherein the first communication interface includes a first connector, and the second communication interface includes a second connector electrically connected to the first connector and to the BMS.

14. The system of claim 11, wherein the BMS includes second processing circuitry configured to:
perform at least one battery management process based on one of the first indication and the third indication.

15. The system of claim 9, wherein the first operation mode is a sleep mode triggering the BMS to consume less power than the second operation mode.

16. A method in a plug, the plug being removably connectable to a battery, the method comprising:
selecting one of a first operation mode and a second operation mode based on at least one of:
a request to switch between the first operation mode and the second operation mode; and
at least one parameter associated with the battery;
the selected first operation mode triggering the battery to operate using a first set of processes, the selected second operation mode triggering the battery to operate using a second set of processes, the first set of processes being a subset of the second set of processes; and
transmitting a first indication indicating one of the selected first operation mode and the selected second operation mode.

17. The method of claim 16, wherein the method further includes:
transmitting the request to switch between the first operation mode and the second operation mode.

18. The method of claim 17, wherein the method further includes:
transmitting the request to trigger the selection between the first operation mode and the second operation mode to be automatic based on the at least one parameter associated with the battery.

19. The method of claim 16, wherein the method further includes:
displaying a second indication of at least one of the at least one parameter, the selected first operation mode, the selected second operation mode, and whether selection between the first operation mode and the second operation mode is automatic.

20. (canceled)

21. (canceled)

22. The method of claim 16, wherein the at least one parameter includes a state of charge.

23. The method of claim 16, wherein the first operation mode is a sleep mode triggering the battery to consume less power than the second operation mode.
